(19) United States
(12) Patent Application Publication
(10) Pub. No.: US 2025/0023869 A1
(43) Pub. Date: Jan. 16, 2025

(54) SYSTEM AND METHOD FOR COLLABORATIVE PASSWORD MANAGEMENT

(71) Applicant: The Travelers Indemnity Company, Hartford, CT (US)

(72) Inventors: Christopher D. SNAY, Lisbon, CT (US); Monika TWARDOWSKA, Cromwell, CT (US); Sam O. LEE, Glastonbury, CT (US); Joseph A. BUONOCORE, Manchester, CT (US); Kyle J. FOURNIER, West Hartford, CT (US)

(21) Appl. No.: 18/222,178

(22) Filed: Jul. 14, 2023

(51) Int. Cl. H04L 9/40

(52) U.S. Cl. CPC H04L 63/0876; H04L 63/101; H04L 63/20

(57) ABSTRACT

A collaborative security management system and methods are presented. The system includes a processor communicating with two or more user devices and memory communicating with the processor. The memory stores instructions that when executed result in the processor storing two or more data structures in memory. Each data structure includes secured information. The processor establishes at least one safe associated with the data structures and defines security rules for the safe. Each rule governs one of an access and an operations privilege. The access privilege grants or denies access to the safe by the user devices via an interface. The operations privilege enables or disables performance of operations upon the safe initiated by the user device from the interface. The processor controls, by the security rules, at least one of access to and operations performed upon the safes and data structures associated therewith by the user devices.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent files or records, but otherwise reserves all copyright rights whatsoever.

### BACKGROUND OF THE INVENTION

### 1. Technical Field

The present disclosure relates generally to collaborative security management systems and methods thereof and, more particularly, the present disclosure is related to systems and methods for managing secured information between two or more users including collaborative ways to govern access to and operations performed on the secured information.

### 2. Related Art

Many software applications and Internet websites such as, for example, banking and social networking websites, manage access and execution of their functionality by requiring users to provide credentials to sign-on or otherwise verify their permission to use the software application and/or website. As such, users maintain many credentials such as, for example, username and password combinations. Given the number of software applications and websites people use daily and weekly, it is burdensome to remember several different credentials. Conventional password management software has been developed that allows users to enter and store their credentials. The management software, which typically requires its own login credentials, can be utilized by the users to later retrieve stored credentials as needed to access the software applications or websites, thus minimizing, if not eliminating, the need to remember all of the different credentials of the user.

Generally speaking, conventional password management software is designed for use by a single user and does not readily permit sharing of stored credentials between two or more users. To the contrary, such sharing is discouraged as it is believed to compromise the security of a system. However, there are instances where such sharing is required within a group or team of two or more users. In such situations, group or team members must manually share credentials with other team members or provide access to their stored credentials by sharing their credentials to access the password management software itself, in effect having two or more users using one account within the password management software. Neither of these options is preferred. For example, when two or more users share one account, nothing within the one account is confidential as all users can access all credentials associated with the account. Accordingly, there is a need for a collaborative security management system and methods thereof.

### SUMMARY OF THE INVENTION

The present invention is directed to a collaborative security management system and methods for implementing the same. The system includes a processing device in communication with two or more user devices. The system also includes a memory device in communication with the processing device. The memory device stores instructions that when executed by the processing device result in the processing device storing two or more data structures in the memory device. Each of the data structures includes secured information. The processing device establishes at least one safe associated with one or more of the data structures and defines one or more security rules for the safe. Each of the security rules governs for one or more of the user devices at least one of an access privilege and an operations privilege. The access privilege grants or denies access to at least one of the safe and the one or more data structures associated therewith by the one or more of the user devices via an interface. The operations privilege enables or disables performance of operations upon at least one of the safe and the one or more data structures associated therewith initiated by the one or more of the user devices from the interface. The processing device also controls, by application of the security rules, at least one of access to and operations performed upon at least one safe and the one or more data structures associated therewith by the one or more of the user devices.

In one embodiment, the secured information includes at least one of login credentials, cryptographic keys, documents, and data strings. In one embodiment, at least a portion of the secured information is encrypted prior to storing in the memory device. In another embodiment, when one or more user devices access the safe and the one or more data structures associated therewith, the encrypted secured information remains encrypted when presented on the interface until selected for decrypting and viewing on the interface.

In one embodiment, one of the user devices initiates establishing of the safe. In one embodiment, the user device establishing the safe initiates defining the one or more security rules for the safe. In another embodiment, an administrator of the security management system initiates establishing of the safe. In one embodiment, the administrator also initiates the defining of the one or more security rules for the safe.

In one embodiment, the access privilege includes at least one of read-only access and read-and-write access to at least one of the safes and the one or more data structures associated therewith. In one embodiment, the operations privilege includes operations of at least one of adding, modifying, deleting, copying, and sharing between one or more of the plurality of user devices at least one of the safes and the one or more data structures associated therewith. In yet another embodiment, the operations privilege includes an operation of at least one of executing an application, accessing a document, and following a link to access an account presented on the interface and providing a portion of the secured information to execute the application, to access the document, and to access the account. In one embodiment, the operation of executing, accessing, and/or following a link to access an account further includes verifying the one or more of the user devices performing the operation is compatible with the at least one of the application to be executed, the document to be accessed, and the account to be accessed prior to initiating performance of the operation.

### BRIEF DESCRIPTION OF THE DRAWINGS

Referring now to the Figures, which are exemplary embodiments, and wherein like elements are numbered alike.

FIG. 1 is a schematic diagram of a collaborative security management system, according to one embodiment of the present invention.

FIGS. 2A and 2B are graphical user interfaces depicting exemplary dashboard pages where a user views, accesses, and/or modifies safes and secured information therein depicted in the system of FIG. 1, according to one embodiment of the present invention.

FIGS. 3A and 3B are graphical user interfaces depicting an exemplary MySafes page where a user invokes features and functions of the system of FIG. 1 to create and/or to modify safes established in the system, according to embodiments of the present invention.

FIGS. 4A to 4D are graphical user interfaces depicting exemplary pages where a user invokes features and functions of the system of FIG. 1 to create and/or to modify secured information within a safe established in the system, according to embodiments of the present invention.

FIG. 5 is a graphical user interface depicting an exemplary page where a user invokes features and functions of the system of FIG. 1 to share a safe established in the system with one or more other users of the system, according to one embodiment of the present invention.

FIG. 6 is simplified table or matrix view of rules defining access and operations privileges of users and associated safes established in the system of FIG. 1, according to one embodiment of the present invention.

FIG. 7 is a graphical user interface depicting an exemplary feature and function of the MySafes page of FIG. 3A where a user invokes features and functions of the system of FIG. 1 to create and/or to modify rules for safes and associated users of the system, according to embodiments of the present invention.

### DETAILED DESCRIPTION OF PREFERRED EMBODIMENTS

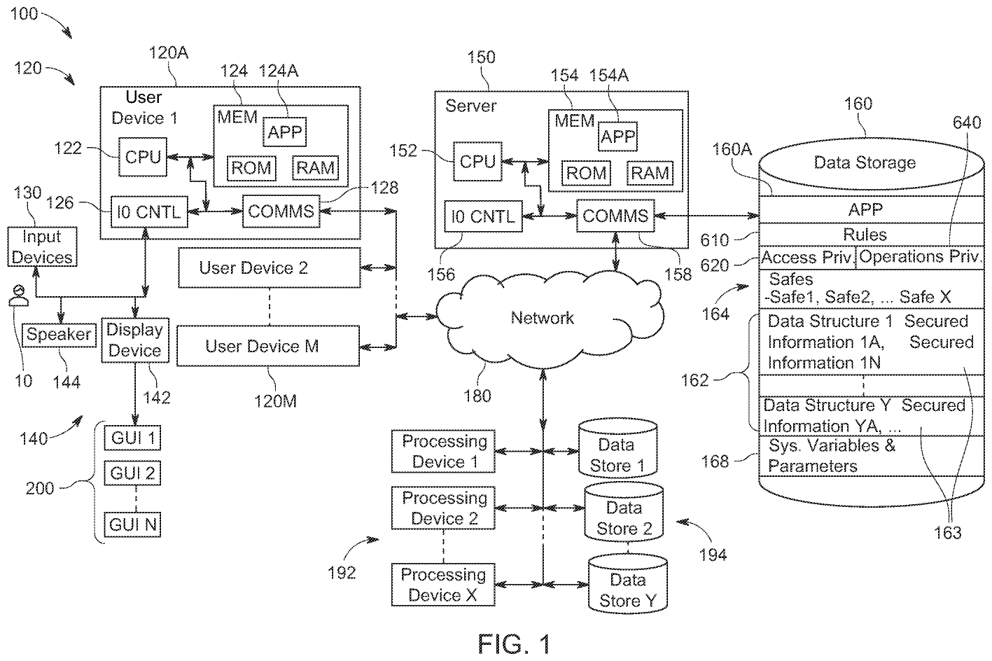

FIG. 1 depicts a simplified block diagram view of a collaborative security management system 100, according to one embodiment. The system 100 includes a plurality of client or user devices, shown generally at 120, including user devices 120A to 120M, operatively coupled to and in communication with a network 180. In one embodiment, each of the user devices 120 includes or is operatively coupled via the network 180 to one or more processors (CPU) 122 or processing devices 192, memory (e.g., internal memory (MEM) 124 including hard drives, ROM, RAM, and the like), and/or data storage devices 194 (e.g., hard drives, optical storage devices, and the like) as is known in the art. In one embodiment, each of the user devices 120 includes or is operatively coupled to one or more input devices 130 and one or more output devices 140 via an input/output controller (IO CNTL) 126. In one embodiment, the input devices 130 include, for example, a keyboard, mouse, stylus, or like pointing device, buttons, wheels, touch pad, or touch screen portions of a display device, or input ports for receiving and providing data and information to the user device 120. In one embodiment, the output devices 140 include, for example, one or more display devices 142 integral with or operatively coupled to the user device 120 to exhibit visual output, a speaker 144 to provide audio output, and/or a printer (not shown) to provide printed output. In one embodiment, the visual and printed output includes documents, images, and other visual representations of data and information from the system 100. In one embodiment, the display devices 142 exhibit one or more graphical user interfaces (GUIs) 200 (as described below) that may be visually perceived by a user/operator 10 operating one of the user devices 120. It should also be appreciated that for clarity purposes, components (e.g., CPU, MEM, IO CNTL, input and output devices and the like) are depicted in FIG. 1 only with reference to User Device 1 but equally may correspond to one or more of the other user devices (User Device 2 to User Device M). In one embodiment, the user devices 120 include, for example, a personal computer or workstation, or portable computer processing devices such as, for example, a personal digital assistant (PDA), iPAD™ device, tablet, laptop, mobile radio telephone, smartphone (e.g., Apple™ iPhone™ device, Google™ Android™ device, etc.), or the like. It should be appreciated that the designations Apple, iPhone, and iPad are trademarks of Apple Inc. of Cupertino, California. It should also be appreciated that the designations Google and Android are trademarks of Google LLC of Mountain View. California.

In one embodiment, the system 100 and each of the user devices 120 may be operatively coupled to and in communication with, via the network 180, a server 150. In one embodiment, the server 150 includes one or more processors (CPU) 152, memory (e.g., internal memory (MEM) 154 including hard drives, ROM, RAM, and the like), an input/output controller (IO CNTL) 156 for receiving and outputting data and information via input and output devices coupled thereto (not shown), and/or one or more data storage devices 160 (e.g., hard drives, optical storage devices, and the like) as is known in the art. In one embodiment, illustrated in FIG. 1, each of the user devices 120 and the server 150 include communication circuitry (COMMS) 128 and 158, respectively, such as a transceiver, for operatively coupling the user devices 120 and the server 150 by wired or wireless communication connections to the network 180 such as, for example, a local area network (LAN), an intranet, extranet, or the Internet, and to a plurality of processing devices 192 (e.g., processing devices 1 to X) and/or data storage devices 194 (e.g., data stores 1 to Y), also operatively coupled to and communicating with the network 180. It should be appreciated that, while not shown, the network 180 may include, for example, cell towers, routers, repeaters, ports, switches, and/or other network components that comprise the Internet and/or a cellular telephone network and/or Public Switched Telephone Network (PSTN), as is known in the art. It should also be appreciated that the network 180 may include or utilize, for example, components and/or resources in a “cloud” or virtual environment. It should also be appreciated that in one embodiment, for example, an implementation within a corporate enterprise, the system 100 integrates with the enterprise's single sign-on (SSO) service application to provide a user's credentials (e.g., username and password) stored within the system 100 to one or more SSO-integrated applications to facilitate automatic, seamless sign-on to the user's accounts, applications, and/or enterprise platforms using relevant credentials. In still another embodiment, the enterprise's SSO service application is accessed before entry into the system 100 such that successful SSO-based authentication is required before data and information stored within the system 100 is accessible to the user.

In one embodiment, the user devices 120 and the server 150 cooperate to implement the collaborative security management system 100 that controls access to and operations performed upon one or more data structures, shown generally at 162, stored within, for example, the data storage device 160 and/or the data storage devices 194. In one embodiment, the data structures 162 store secured information 163 including, for example, at least one of login credentials (e.g., username and password, or other information to authenticate or verify the identity of a user), cryptographic certificates or keys, verification codes, documents, and sensitive or secret character or data strings, e.g., alphanumeric character strings, photographs, or images. In one aspect of the security management system 100, the user devices 120 and the server 150 execute a plurality of programmable instructions of a multifunctional software application or app (e.g., “APP”) of the system 100, or portions or modules thereof, 124A, 154A, or 160A, stored in local memory 124, 154, or network memory 160, respectively, to implement the collaborative security management system 100 and features and/or functions thereof. In one embodiment, users of the system 100 (e.g., the operators 10 operating the user devices 120) may be granted differing authorizations or permissions and/or levels thereof, to execute various ones of the features and/or functions of the system 100. For example, the authorizations or permissions may specify whether a user may be able to access and/or manipulate, e.g., perform operations upon, information stored within the system 100, as described herein. In one embodiment, various variables and parameters, shown generally at 168, that are used by the system 100, are stored in the data storage device 160.

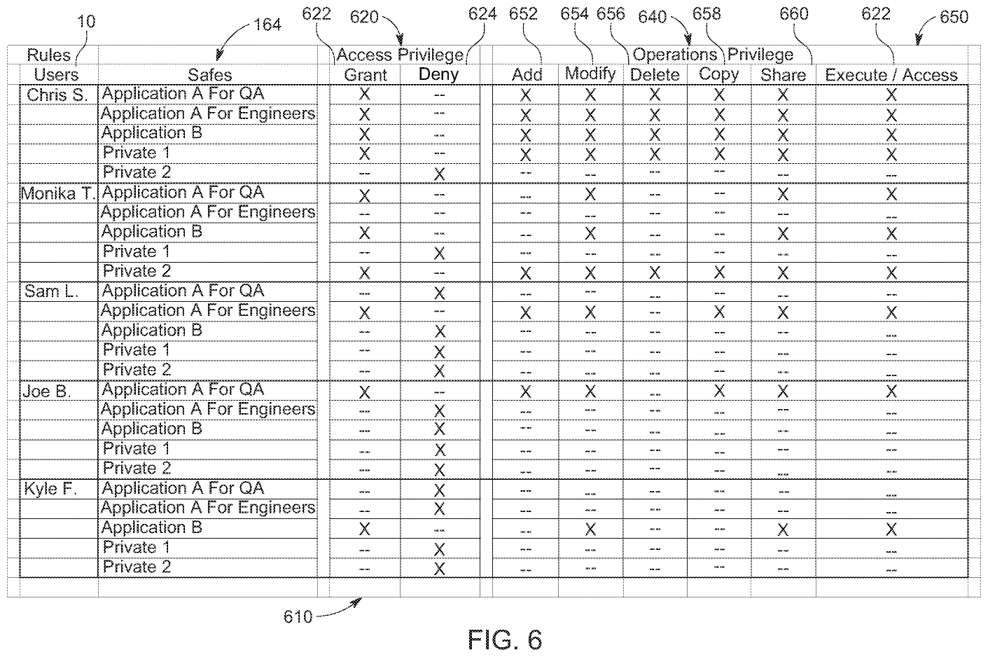

In one embodiment, one or more of the APPs 124A, 154A, 160A are executed to establish one or more safes, shown generally at 164, that are associated with or linked to one or more of the data structures 162. The APPs 124A, 154A, 160A may also be executed to define one or more security rules, shown generally at 610 of FIGS. 1 and 6, for the safes 164. Each of the security rules 610 governs, for the operators 10 of the one or more of the user devices 120, at least one of an access privilege, shown generally at 620, and an operations privilege, shown generally at 640, with respect to one or more of the safes 164. In one embodiment, the security rules 610 define the access privilege 620 as granting access 622 or as denying access 624 to at least one of the safes 164 and the one or more data structures 162 associated therewith, by the operators 10 of the one or more of the user devices 120 via an interface. In one embodiment, the interface includes, for example, one of the aforementioned graphical user interfaces (GUIs) 200 (described in detail below). In one embodiment, the security rules 610 may also define the operations privilege 640 as enabling or as disabling performance of operations, shown generally at 650 of FIG. 6, upon at least one of the safes 164 and the one or more data structures 162 associated therewith, initiated by the operators 10 of the one or more of the user devices 120 from the interface. In one embodiment, operations 650 include, but are not limited to at least one of an add 652, modify 654, delete 656, copy 658, and share 660 between one or more of the operators 10 of the user devices 120 at least one of the safes 164 and the one or more data structures 162 associated therewith. In one embodiment, the operations privilege 640 may also include the operation 650 of at least one of executing an application, accessing a document, or following a link to access an account presented by the interface (e.g., an execute/access operation 662). In one embodiment, the execute/access operation 662 includes providing a portion of the secured information (e.g., login credentials) to execute the application, to access the document, and to access the account as an authorized user thereof.

As used herein, the term “safe” is meant to broadly include any logical association, link, pointer, or other connection to one or more of the data structures 162, and is not intended to be limited by one or more exemplary manners of associating or storing data. As described below, when the operator 10 of one of the user devices 120 accesses one of the safes 164 via the interface, the safe 164 is opened and the data structures 162 associated with the accessed safe 164 can be viewed and, as appropriate, operations performed thereon. It should be appreciated that while the one or more security rules 610 are depicted in FIG. 6 in a table or matrix manner illustrating authorizations or permissions for the users of the system 100 (e.g., the operators 10 of the user devices 120) with respect to the one or more safes 164 and respective access privilege 620 and an operations privilege 640 thereof, this presentational format is merely exemplary and is not intended to be limiting, as other storage mechanisms and associations for establishing and applying access privileges and operations privileges to the safes 164 and contents thereof are within the scope of the present invention.

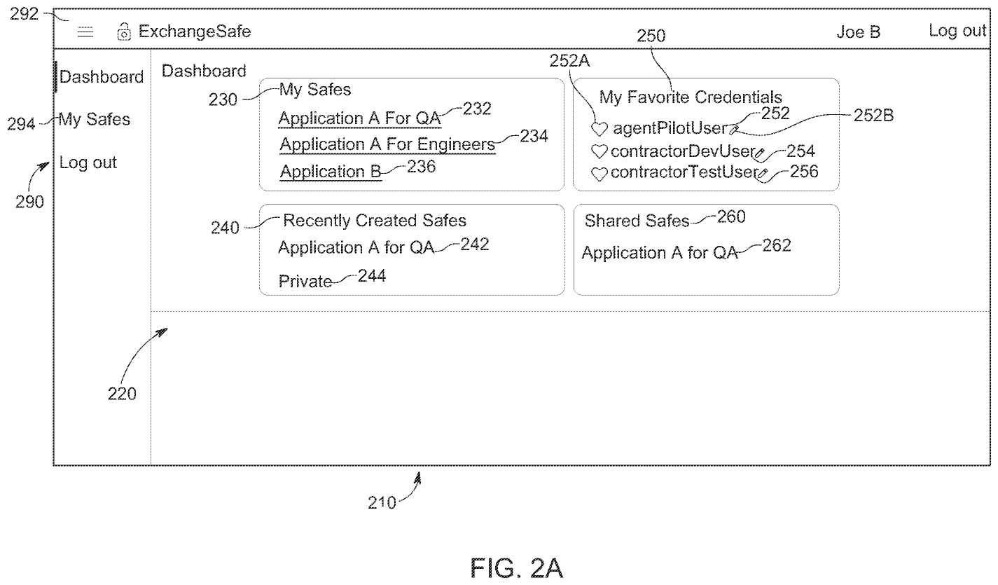

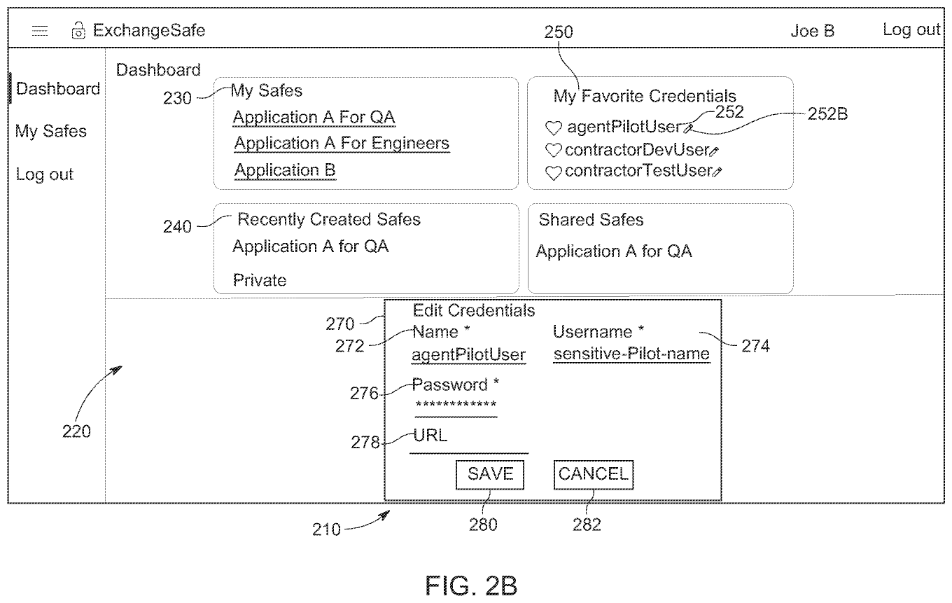

As noted above, the users of the system 100 (e.g., operators 10 of one of the user devices 120) interact with one or more of the safes 164 via the interface, which includes one of the GUIs 200. For example, FIG. 2A depicts a Dashboard GUI 210, in accordance with one embodiment. As shown in FIG. 2A, the Dashboard GUI 210 includes one or more regions, shown generally at 220, that exhibit navigation hyperlinks or icons representing one or more of the safes 164 or one or more of the secured information items 163, or portion thereof, stored in one of the data structures 162, that an authorized user, e.g., operator 10 of one of the user devices 120, of the system 100 may interact with, for example, has created or has been given access to view or to perform operations upon. In one embodiment, the Dashboard GUI 210 includes a “My Safes” region 230, a “Recently Created Safes” region 240, a “My Favorite Credentials” region 250, and a “Shared Safes” region 260. In one embodiment, the My Safes region 230 includes a first navigation link 232 labeled “Application A for QA” to a first one of the safes 164, a second navigation link 234 labeled “Application A for Engineers” to a second one of the safes 164, and a third navigation link 236 labeled “Application B” to a third one of the safes 164. As noted above, the navigation links 232, 234, 236, when selected, provide access to a respective safe 164 that the authorized user/operator 10 of the user device 120 is an “owner of” (defined below) or has been given a privilege (e.g., access privilege or operations privilege) to interact with. Similarly, the Recently Created Safes region 240 includes a first navigation link 242 labeled “Application A for QA” and a second navigation link 242 labeled “Private,” each of which provides access to a respective one of the safes 164 associated with the navigation links 242 and 244 that the authorized user/operator of the user device 120 recently created. The Shared Safes region 260 includes a first navigation link 262 labeled “Application A for QA”, which provides access to a respective one of the safes 164 associated with the navigation link 262 that the authorized user/operator of the user device 120 recently shared with other users or that another user has shared with the current user. In one embodiment, the My Favorite Credentials region 250 includes a first navigation link 252 labeled “agentPilotUser” to a first one of the secured information items 163, a second navigation link 254 labeled “contractorDevUser” to a second one of the secured information items 163, and a third navigation link 256 labeled “contractorTestUser” to a third one of the secured information items 163, each of which provides access to a respective one of the secured information items 163 associated with the navigation links 252, 254, 256, e.g., in one embodiment, a login credential (e.g., username and password).

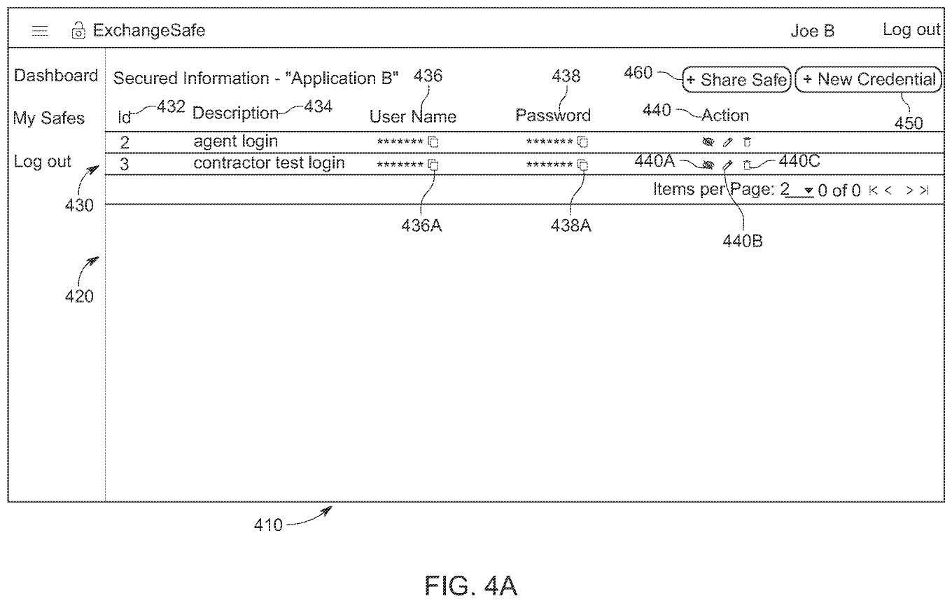

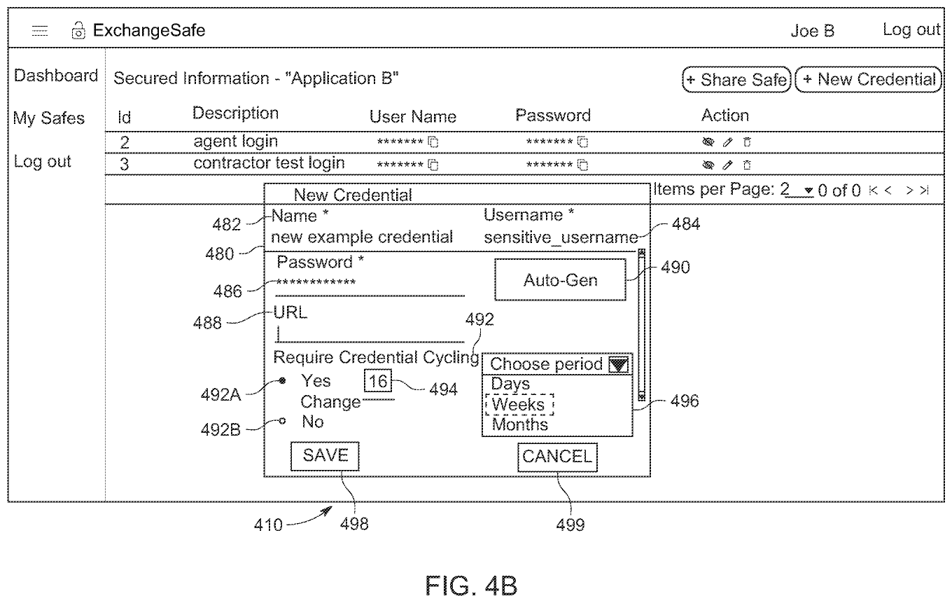

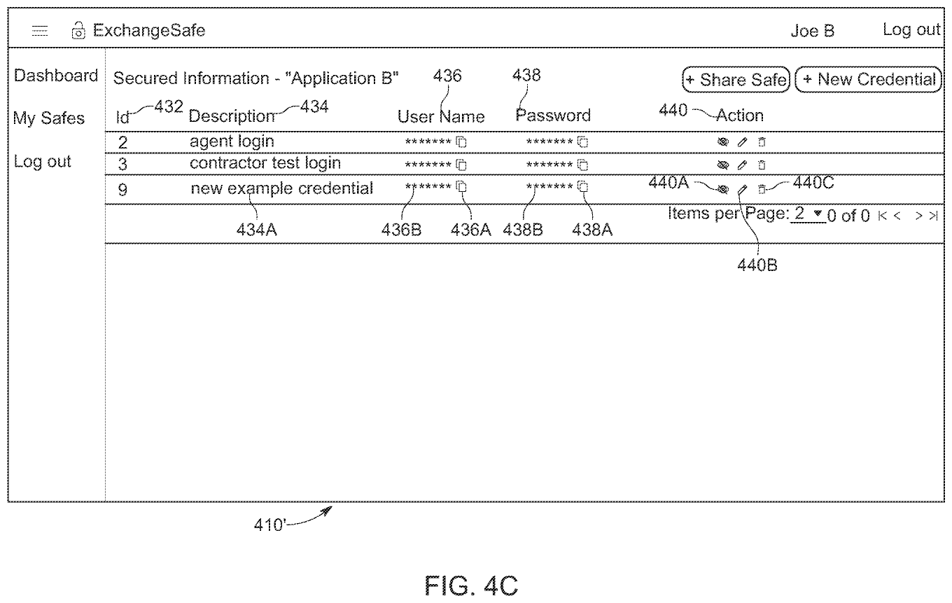

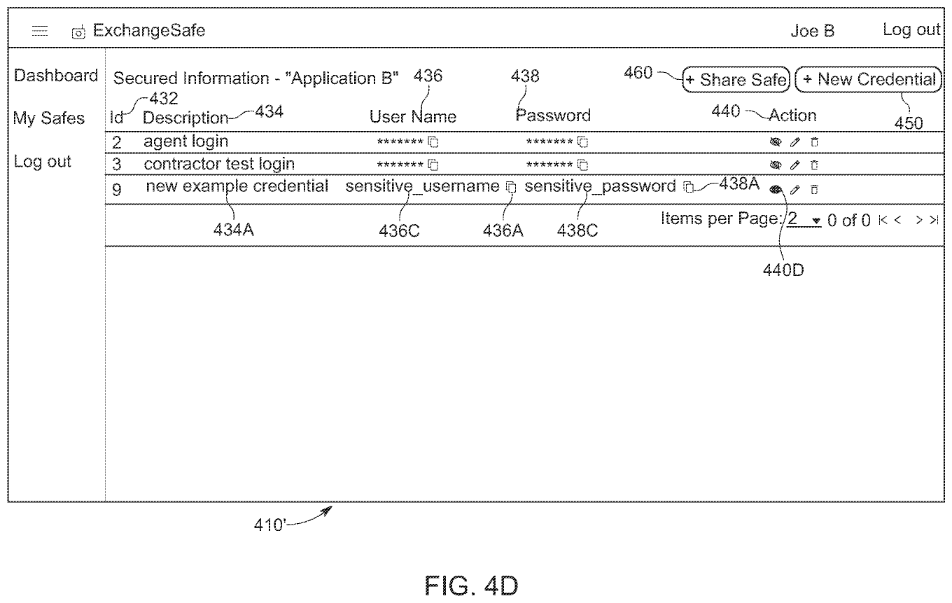

In one embodiment, the user may identify and mark a “favorite” one of the secured information items 163 that the system 100 includes within the My Favorite Credentials region 250. In one embodiment, the favorite secured information items 163 are indicated by a “Heart” icon 252A exhibited in the My Favorite Credentials region 250. In one embodiment, the My Favorite Credentials region 250 also includes a shortcut to an edit action for a selected one of the secured information items 163 exhibited as a “Pencil” icon 252B. When the Pencil icon 252B is selected for a selected one of the secured information items 163 exhibited in the My Favorite Credentials region 250 one or more of the APPs 124A, 154A, 160A are executed to invoke an “Edit Credentials” dialog box 270 exhibited in one of the regions 220 of the Dashboard GUI 210 depicted in FIG. 2B. In the Edit Credentials dialog box 270 the user accesses the selected one of the secured information items 163 to review and, as appropriate, modify (e.g., manually change) the contents thereof. For example, in the Edit Credentials dialog box 270 the user may modify a name value of the selected secured information item 163 itself, as well as one or more values of the selected secured information items 163, e.g., a username, password, and/or URL, at fields 272, 274, 276, and 278, respectively, of the Edit Credentials dialog box 270. It should be appreciated that in one embodiment, one or more of the values of the selected secured information item 163 are “required” entries, e.g., entries that are required to have a non-blank or non-null value. In one embodiment, these required entries are indicated on the Edit Credentials dialog box 270 by an asterisk symbol (“*”) following the field 272, 274, and 276. To save the modified values, the user selects a “Save” control button 280. Alternatively, the user ends the edit operation by selecting a “Cancel” control button 282. In one embodiment, selecting the Save control button 280 or the Cancel control button 282 closes the Edit Credentials dialog box 270 and invokes or reactivates the Dashboard GUI 210 (FIG. 2A). It should be appreciated that the GUIs 210 of FIGS. 2A and 2B are substantially the same, except that an edit operation was invoked and the Edit Credentials dialog box 270 is depicted on the GUI 210 of FIG. 2B. It should also be appreciated that in one embodiment the Edit Credentials dialog box 270 of FIG. 2B may include additional fields for modifying one or more other values of the selected secured information items 163. For example, as shown in FIG. 4B (described below), the additional fields of the Edit Credentials dialog box 270 (FIG. 2B) may include an auto-generation field 490 and a credential cycling field 492 described below in relation to a New Credential dialog box 480 (FIG. 4B).

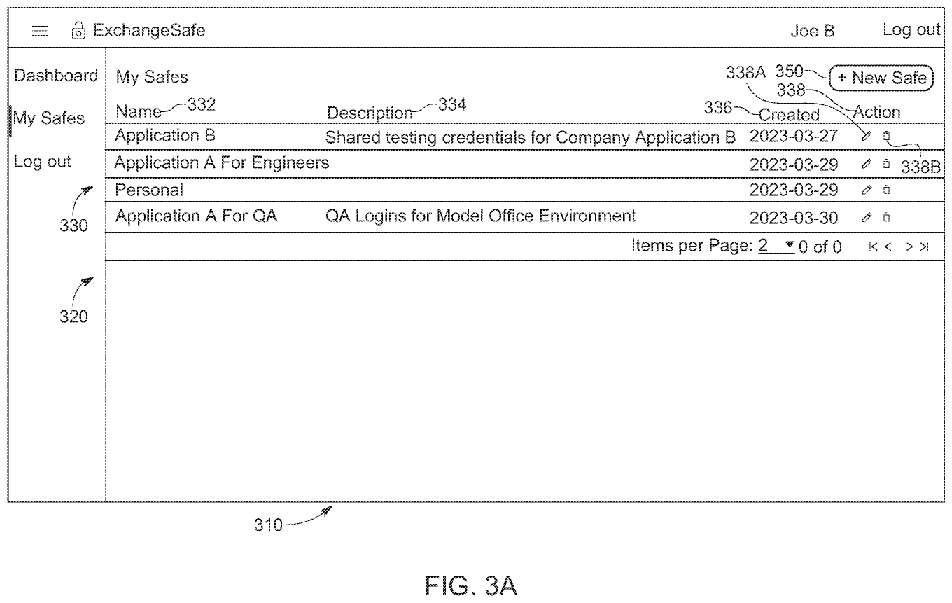

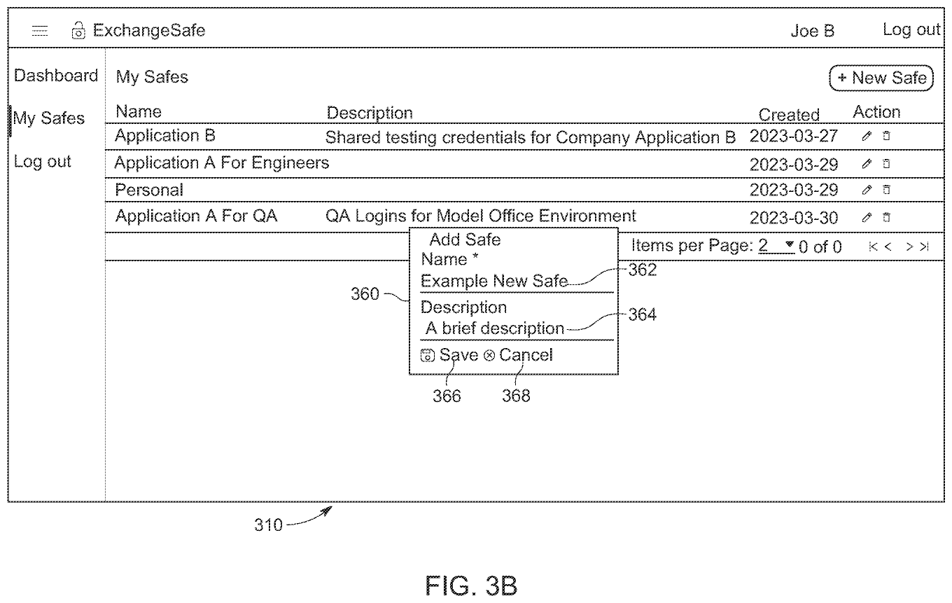

Referring again to FIG. 2A, in one embodiment, locations within the Dashboard GUI 210 and contents of the one or more regions 220 are adaptable or configurable by the user/operator 10 of each user device 120, for example, by a “drag and drop” action to relocate, reorder, reformat, or resize regions 220 and/or navigation links, e.g., links 232, 234, 236 within a region. It should be apparent that although specific types of navigation controls are shown in FIGS. 2A and 2B, other embodiments may use different types of controls to implement the functionality described herein. For example, although textual, navigation hyperlinks are shown, the functionality can be invoked with other types of navigation controls such as an icon, a menu, a dropdown menu, radio buttons, checkboxes, lists, or the like. In one embodiment, each of the GUIs 200 of the collaborative security management system 100, for example the exemplary Dashboard GUI 210 illustrated in FIGS. 2A and 2B, may include one or both of a Main Menu navigation bar 290 and/or a Main Menu dropdown 292, which may be selected to navigate through the GUIs 200. For example, a “My Safes” option 294 may be selected to navigate to a My Safes GUI 310 depicted in FIGS. 3A and 3B.

As shown in FIG. 3A, the My Safes GUI 310 provides an expanded, more detailed view of one or more of the safes 164 within one or more regions, shown generally at 320. For example, in a region 330, a list of safes 164 created by or assigned to an authorized user, e.g., the operator 10 of one of the user devices 120 of the system 100, are exhibited. In one embodiment, each of the safes 164 are associated with an owner that executes functions of the collaborative security management system 100, as described herein, to define one or more of the security rules 610 for the safes 164. In one embodiment, the authorized user that creates a safe is, by default, identified as the owner of the created safe. In one embodiment, an administrator of the system 100 or a senior one of the authorized users (e.g., a user given relatively high authorization or permission to execute features and/or functions of the system 100) may assign and/or reassign an owner of one or more of the safes 164. Accordingly, the safes 164 for which the user is the owner are exhibited with the list of safes 164 in the region 330 of the My Safes GUI 310. In one embodiment, shown in FIG. 3A, the region 330 includes a “Name” column 332, a “Description” column 334, a “Created” column 336, and an “Action” column 338, each exhibiting, where appropriate, respective values for the safes 164 within the list. In one embodiment, the name and description values for the safes 164 are defined by the owner of the respective safe 164, while the value in the Created column 336 (e.g., a date value) is assigned by the system 100 when a safe 164 is first established in the system 100. In one embodiment, the Action column 338 exhibits respective actions or operations that may be performed by the user upon the one or more safes 164 exhibited in the list. For example, actions for the safes 164, exhibited as icons, include an edit action depicted with a “Pencil” icon 338A and a delete action depicted with a “Garbage Can” icon 338B. In one embodiment, the actions exhibited in the Action column 338 include only the actions that a specific one of the users/operators 10 is authorized to perform upon the subject safe 164 as detected from an evaluation of the security rules 610 (e.g., operations privilege 640) for the specific one of the user/operators 10. It should be appreciated that the actions exhibited in the Action column 338 of FIG. 3A are not an exhaustive list of all possible actions that may be performed in the system 100, and they represent only some exemplary actions invoked from the My Safes GUI 310. It should also be appreciated that although specific types of icon controls are shown in FIG. 3A, other embodiments may use different types of controls to implement the functionality described herein. For example, the icons exhibited to invoke specific actions may be replaced with textual, navigation hyperlinks, a menu or a dropdown menu, or the like.

In one embodiment, the My Safes GUI 310 depicted in FIG. 3A also includes a “New Safe” control button 350. When selected, one or more of the APPs 124A, 154A, 160A are executed to invoke an “Add Safe” dialog box 360 exhibited in another one of the regions 320 of the My Safes GUI 310 depicted in FIG. 3B. In the Add Safe dialog box 360 the user establishes a new one of the safes 164 by defining, for example, a name and description of the safe 164 in fields 362 and 364, respectively, of the Add Safe dialog box 360. To create the new safe, the user selects a “Save” control button 366. Alternatively, the user ends the creation operation by selecting a “Cancel” control button 368. In one embodiment, selecting the Save control button 366 or the Cancel control button 368 closes the Add Safe dialog box 360 and invokes or reactivates the My Safes GUI 310 (FIG. 3A). As depicted in FIG. 3A, the user selects the Pencil icon 338A to invoke the edit action for a particular safe, or the Garbage Can icon 338B to invoke the delete action for the particular safe. As shown in FIG. 3A, when the user selects the Pencil icon 338A the system 100 invokes the edit action for a specified or selected one of the safes 164 associated with the selected Pencil icon 338A (e.g., the “Application B” safe 164) and exhibits a Secured Information GUI 410 of FIG. 4A.

As shown in FIG. 4A, the Secured Information GUI 410 provides an expanded, more detailed view of the contents of secured information items 163 within the selected one of the safes 164 (e.g., the “Application B” safe 164) within one or more regions, shown generally at 420. For example, in a region 430 the contents of the selected safe “Applications B” includes a list of secured information items 163, or portions thereof, associated with the Application B safe. In one embodiment, shown in FIG. 4A, the region 430 includes an “Id” column 432, a “Description” column 434, a “User Name” column 436, a “Password” column 438, and an “Action” column 440 exhibiting, where appropriate, respective values for the secured information items 163 within the selected one of the safes 164. In one embodiment, the Id, Description, User Name, and Password values for the secured information items 163 are initially defined and/or subsequently redefined by a creator or owner of the respective safe (e.g., Application B safe 164). In one embodiment, subsequent values for the Id, Description, User Name, and Password fields for a respective one of the secured information items 163 within the safe 164 may be updated by other users of the system 100 provided the user has an appropriate permission or authorization as defined by the security rules 610 for the user and safe 164 (as defined below). In one embodiment, a portion of the exhibited secured information items 163, for example, the values within the User Name column 436 and the Password column 438 within the region 430 are obfuscated, blocked, or concealed (e.g., exhibited as a series of asterisks (“*”) or other character values) on the GUI 410 so that the actual values are not immediately discernible by viewing the Secured Information GUI 410 (FIGS. 4A to 4D). In one embodiment, the User Name column 436 and the Password column 438 of the region 430 of the Secured Information GUI 410 include “Copy” icons, shown generally at 436A and 438A, respectively, for each one of the secured information items 163 exhibited on the Secured Information GUI 410. When either of the Copy icons 436A and 438A of an associated one of the User Name or Password values in columns 436 and 438 is selected one or more of the APPs 124A, 154A, 160A are executed to copy the value of the associated User Name and Password field to a temporary storage area or buffer within a user's computing device, e.g., the device's clipboard space in a RAM portion of its memory 124, for use or transfer of the value to another application executing or to be executed on the computing device, or other use. In one embodiment, the copy operation is performed without revealing the value of the copied field.

In one embodiment, the Action column 440 exhibits respective actions or operations that may be performed upon the secured information items 163 exhibited in the list of the selected safe. In one embodiment, the actions exhibited in the Action column 440 include only the actions that a specific one of the users/operators 10 is authorized to perform upon the subject secured information item 163 as detected from an evaluation of the security rules 610 (e.g., operations privilege 640) for the specific one of the user/operators 10. For example and as depicted in FIG. 4A, actions for the secured information items 163, exhibited as icons, include a reveal, unblock, or unconceal values of a selected one of the secured information items 163 action depicted with an “Eye” icon 440D (depicted in FIG. 4D) and, alternatively, obfuscate, block, or conceal the values of the selected one of the secured information 163 action depicted with an “Eye with Slash” icon 440A (FIG. 4A), an edit action depicted with a “Pencil” icon 440B, and a delete action depicted with a “Garbage Can” icon 440C. As described below, the Eye icon 440D and the Eye with Slash icon 440A may be toggled therebetween to view or conceal one or more values of the selected one of the secured information items 163 (see description below regarding FIG. 4D). It should be appreciated that the exhibited actions are not an exhaustive list of possible actions, only of exemplary actions that may be invoked from the Secured Information GUI 410. It should also be appreciated that although specific types of icon controls are shown in FIG. 4A, other embodiments may use different types of controls to implement the functionality described herein. For example, the icons exhibited to invoke specific actions may be replaced with textual, navigation hyperlinks, a menu or a dropdown menu, or the like. In one embodiment, the actions or operations that may be performed by the user/operator 10 upon the secured information items 163 of a respective safe 164 exhibited in the list in region 430 may vary depending on permission or authorization as defined by the security rules 610 for the user/operator 10 and safe 164 (as defined below). Accordingly, the system 100 exhibits the Action icons associated with the particular user's permission or authorization under the security rules 610.

In one embodiment, the Secured Information GUI 410 depicted in FIG. 4A also includes a “New Credential” control button 450. When selected, one or more of the APPs 124A, 154A, 160A are executed to invoke a “New Credential” dialog box 480 exhibited in one of the regions 420 of the Secured Information GUI 410 depicted in FIG. 4B. It should be appreciated that as defined herein the secured information items 163 includes, for example, at least one of login credentials (e.g., username and password, or other information to authenticate or verify the identity of a user), cryptographic certificates or keys, verification codes, documents, and sensitive or secret character or data strings, e.g., alphanumeric character strings, photographs, or images. For brevity, the functionality of the New Credential dialog box 480 is described with reference to defining new login credentials (e.g., username and password combination). However, it should be appreciated that the New Credential dialog box 480 may be used to define any type of a new secured information item 163 and enter values thereof.

In the New Credential dialog box 480 the user establishes a new one of the secured information items 163, including login credentials, by defining, for example, entering values (e.g., manually inputting or automatically generating) of a name for the credential, a username, and a password for the credential in fields 482, 484, and 486, respectively, of the dialog box 480. In one embodiment, the New Credential dialog box 480 also includes a URL (uniform resource locator) field 488 identifying an address for a resource on the network 180, e.g., a unique Internet address or the like, to be accessed and when accessed, the secured information item 163 or portion thereof (e.g., values within the Username and Password fields) is provided to gain access thereto. In one embodiment, the URL field 488 may include a name of an executable file such as a secured software application (e.g., a “.exe” file which is secured in that credentials are required to execute the denoted application) entered by the user that is invoked to launch and/or execute an instance of the secured software application. In this exemplary embodiment, the contents of the secured information item 163, e.g., username and password, are automatically provided to the secured software application and configured as login credentials required to execute the secured software application. In one embodiment, the New Credential dialog box 480 also includes an “Auto-Gen” control button 490. When selected, one or more of the APPs 124A, 154A, 160A are executed to automatically define (e.g., generate and automatically entered or fill into), in various embodiments, one or both of the values for the Username and Password fields 484 and 486 of the New Credential dialog box 480 with, for example, random vales of a username and/or password. In still another embodiment, the New Credential dialog box 480 includes a “Require Credential Cycling” field 492 whereby periodic cycling or rotation of values of the selected credential is selectively enabled or disabled. For example, in one embodiment illustrated in FIG. 4B, the Require Credential Cycling field 492 for a selected one of the secured information items 163 is a binary choice, e.g., cycling/rotation is required with a selection of a “Yes” radio button control 492A or cycling/rotation is not required with a selection of a “No” radio button control 492B. Therefore, when one of the options for the Require Credential Cycling field 492 is selected (e.g., the “Yes” control 492A is enabled), the other option is deactivated (e.g., the “No” control 492B is disabled). When enabled (e.g., the “Yes” control 492A is selected), one or more of the APPs 124A, 154A, 160A of the collaborative security management system 100 periodically requires the users of the system 100 (e.g., the operators 10 of one of the user devices 120) to define a new, unique one or both of username and/or password values. In one embodiment, the New Credential dialog box 480 provides for a definition of the cycling period. For example, in one embodiment, a numeric value is enterable at a “Change” field 494 (e.g., a value “16” depicted as entered in FIG. 4B) and a dropdown menu control element 496 lists exemplary periods as options that may be selected including, for example, a “Days” item, a “Weeks” item, and a “Months” item (e.g., an item “Weeks” is depicted as selected in FIG. 4B) such that a “16 Week” cycling or rotation period is defined for the “new example credential” secured information item 163. To create the new secured information item 163, the user selects a “Save” control button 498. Alternatively, the user ends the creation operation by selecting a “Cancel” control button 499. In one embodiment, selecting the Save control button 498 or the Cancel control button 499 closes the New Credential dialog box 480 and invokes or reactivates the Secured Information GUI 410 (FIG. 4A).

It should be appreciated that in one embodiment, where a cycling period is specified for one or more of the secured information items 163, the system 100 generates and sends a notification message (e.g., an electronic mail message or the like) to the owner or owners of the safes 164 including the one or more of the secured information items 163 to inform the owners that an end of a particular cycling period is approaching so that the owners may manually generate a new, unique value for the one or more secured information items 163. In one embodiment, the auto-generation of values for the one or more secured information items 163 may be enabled such that the system automatically generates new values for the secured information items 163 that have reached the end of the specified cycling period. In one embodiment implementing this automatic generation feature, the notification message includes a message that new values have already been generated by the system 100 and that it is recommended that the owner access the appropriate or specified safe 164 to retrieve the new, automatically generated values for the secured information items 163.

As depicted on FIG. 4A, the user selects the Pencil icon 440B to invoke the edit action for an associated one of the secure information items 163, or the Garbage Can icon 440C to invoke the delete action for the associated secure information item 163. As shown in FIG. 4C, when the user selects the Pencil icon 440B of a Secured Information GUI 410′ the system 100 invokes the edit action and permits modification to values within the Id column 432, the Description column 434, the User Name column 436, and the Password column 438 of the Secured Information GUI 410′ of FIG. 4C. It should be appreciated that the GUIs 410 (FIG. 4A) and 410′ (FIG. 4C) are substantially the same, except that the “new example credential” created with the aforementioned New Credential dialog box 480 functionality is exhibited, shown generally at 434A, and edit operations are now allowed to the respective values within the Id column 432, the Description column 434, the User Name column 436, and the Password column 438. As shown in FIGS. 4C and 4D, when the user selects the Eye with Slash icon 440A of the “new example credential” item 434A exhibited on the Secured Information GUI 410′ of FIG. 4C, the system 100 responds by revealing, unblocking, or unconcealing values of a selected one of the secured information items 163 (e.g., the concealed username value 436B and password value 438B of the “new example credential” item 434A of FIG. 4C become the unconcealed username value 436C and password value 438C of the “new example credential” item 434A of FIG. 4D) and converts the Eye with Slash icon 440A (FIG. 4C) to the Eye icon 440D (FIG. 4D). With these values revealed as the username value 436C and password value 438C of the “new example credential” item 434A (FIG. 4D), the user may invoke the edit action (e.g., select the Pencil icon) to modify one or both of those previously obfuscated values now made available as values 436C and 438C for modification within the User Name column 436 and the Password column 438 of the “new example credential” item 434A on the Secured Information GUI 410′ of FIG. 4D.

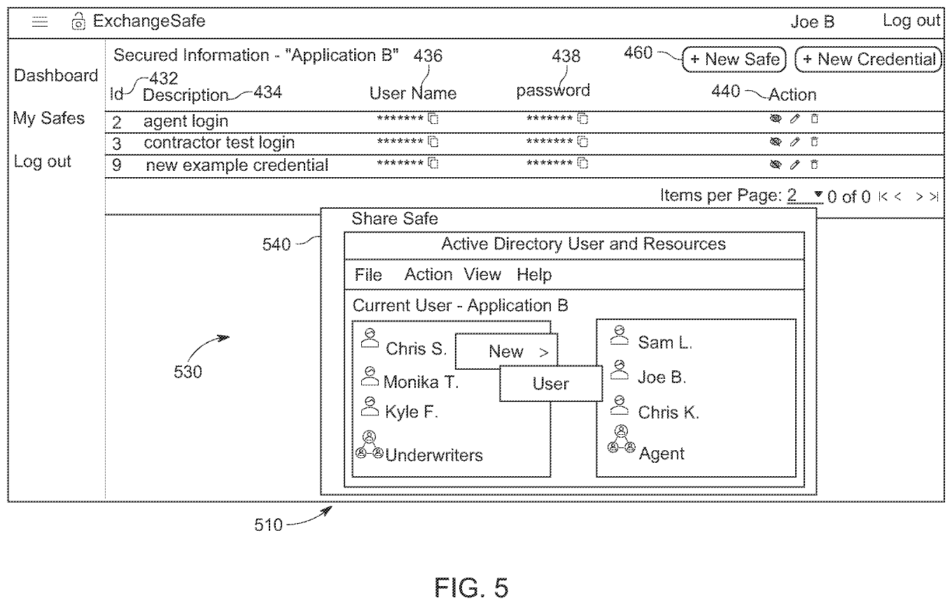

Referring again to FIGS. 4A and 4D, the Secured Information GUIs 410 and 410′ also include a “Share Safe” control button 460. When selected, one or more of the APPs 124A, 154A, 160A are executed to invoke a “Share Safe” dialog box 540 exhibited on a Secured Information GUI 510 depicted in FIG. 5. It should be appreciated that the Secured Information GUI 510 (FIG. 5) is substantially the same as the Secured Information GUIs 410 and 410′ (FIGS. 4A and 4D), where like reference numbers identify like features, except that the Share Safe dialog box 540 is depicted in a region 530 thereof and described separately for clarity of its unique features and functions. In the Share Safe dialog box 540 the owner or other authorized user (e.g., user having authority or permission to execute the Share operation) may share the contents of the selected one of the safes 164 (e.g., Application B exhibited in GUIs 410 and 510) with one or more other users of the system 100. In one embodiment, the Share Safe dialog box 540 executes a directory function such as, for example, Active Directory™ software of Microsoft Corporation, to view and/or to select one of more of the users of the system 100, individually or as a member of a predefined group of users, to share the contents of the safe 164. In one embodiment, once a safe 164 is shared with one or more users, default rules are assigned authorizing the new user to, for example, view the contents of the safe 164 (e.g., access privilege is granted).

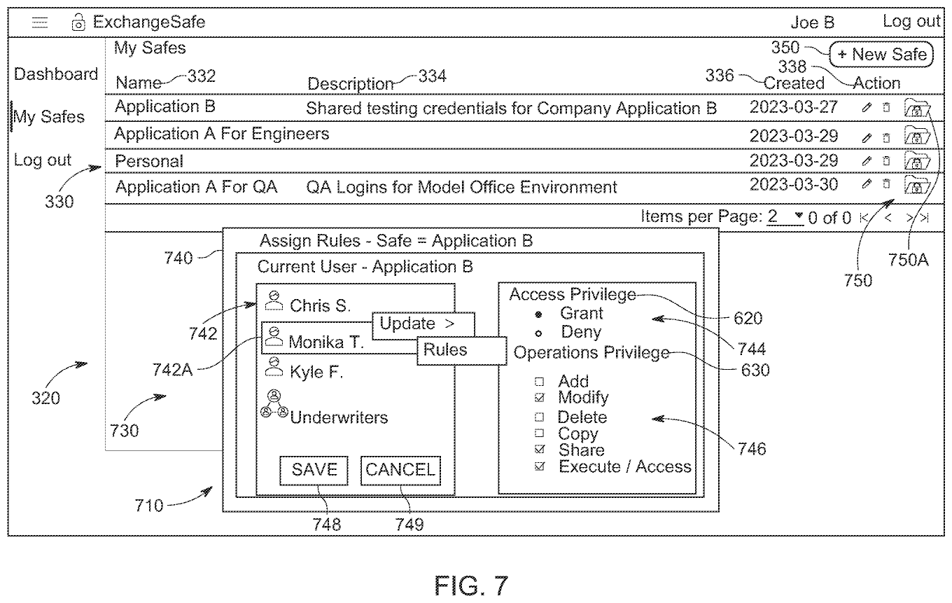

Referring again to FIG. 3A and with reference to FIG. 7, in one embodiment the My Safes GUI 310 (FIG. 3A) also includes one or more “Rules Update” icons, shown generally as 750, associated with each safe 164 exhibited on a My Safes GUI 710 depicted on FIG. 7. When a specific one of the Rules Update icons 750 is selected, e.g., a Rules Update icon 750A for safe Application B, one or more of the APPs 124A, 154A, 160A are executed to invoke a “Rules Update” dialog box 740 for the selected safe (e.g., Application B) exhibited in a region 730 on the My Safes GUI 710 depicted in FIG. 7. It should be appreciated that the My Safes GUI 710 (FIG. 7) is substantially the same as the My Safes GUI 310 (FIG. 3A), where like reference numbers identify like features, except that the Rules Update icons 750 and the Rules Update dialog box 740 are depicted and described separately for clarity of their unique features and functions. In the Rules Update dialog box 740, the owner may update the current rules 610 providing the access privilege 620 and/or the operations privilege 640 of one or more other users of the system 100 associated with the selected one of the safes 164 (e.g., current users granted access to safe Application B exhibited in GUI 710).

In one embodiment, the Rules Update dialog box 740 exhibits a list of users, shown generally at 742, having the access privilege 620 that authorizes the users to view the contents of the selected safe 164 (e.g., the “Application B” safe). Using the Rules Update dialog box 740 the owner of the selected safe 164 can view and/or select one or more of the users accessing the safe 164 (e.g., a user 742A) and, once selected (e.g., a user “Monika T.” 742A is selected), update or revise the access privilege 620 and/or the operations privilege 640 given to the selected user 742A. In one embodiment, current values for the access privilege 620 and the operations privilege 640 assigned to the selected user 742A are exhibited as either enabled (e.g., control element “filled”) or disabled (e.g., control element “unfilled”) in lists, shown generally at 744 and 746, of all available values where a radio button, check box, or like graphical control element, allows the owner to view and change (e.g., enable or disable) the rules 610 that are currently assigned to the selected user 742A. In one embodiment, the access privilege 620 for a selected safe 164 is a binary choice, e.g., access is either granted or denied to the safe 164. Therefore, when one of the options for the access privilege rule 620 is selected (e.g., a “Grant” value), the other option is deactivated (e.g., a “Deny” value). In one embodiment, the operations privilege 640 for a selected one of the safes 164 are not binary therefore, multiple operations 650 (FIG. 6) are exhibited in the list 746 and may be selected (e.g., enabled or disabled) for the selected user 742A and safe 164. Accordingly, the list 746 of available operations 650 (e.g., Add, Modify, Delete, Copy, etc.) are exhibited within the Rules Update dialog box 740, where the owner may select to permit the operation or deselect to deny the operation. For example, as shown in the Rules Update dialog box 740 of FIG. 7, the selected user 742A has been granted access privilege 620 to the “Application B” safe 164 and has been granted the operations privilege 640 to perform Modify, Share, and Execute/Access operations on the “Application B” safe 164. To implement the updates to the rules 610 exhibited on the Rules Update dialog box 740, the owner selects a “Save” control button 748. Alternatively, the user ends the rules update without implementing the decisions made, the user selects a “Cancel” control button 749. In one embodiment, selecting the Save control button 748 or the Cancel control button 749 closes the Rules Update dialog box 740 and invokes or reactivates the My Safes GUI 710 (FIG. 7).

It should be appreciated that the phraseology and the terminology used in the description of the various embodiments described herein should be given their broadest interpretation and meaning as the purpose is for describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising.” when used in this specification, specify the presence of stated features, integers, steps, operations, elements, and/or components, and equivalents thereof, and do not preclude the presence or addition of one or more other features, integers, steps, operations, elements, components, groups and/or equivalents thereof.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A collaborative security management system, comprising:
a processing device in communication with a plurality of user devices; and
a memory device in communication with the processing device, the memory device storing instructions that when executed by the processing device result in:
storing a plurality of data structures in the memory device, each of the data structures including secured information;
establishing at least one safe associated with one or more of the data structures;
defining one or more security rules for the safe, each of the security rules governing for one or more of the user devices at least one of:
an access privilege for granting or for denying access to at least one of the safe and the one or more data structures associated therewith by the one or more of the user devices via an interface, and
an operations privilege for enabling or for disabling performance of operations upon at least one of the safe and the one or more data structures associated therewith initiated by the one or more of the user devices from the interface; and
controlling, by application of the security rules, at least one of access to and operations performed upon the at least one safe and the one or more data structures associated therewith by the one or more of the user devices.

2. The system of claim 1, wherein the secured information includes at least one of login credentials, cryptographic keys, documents, and data strings.

3. The system of claim 1, wherein at least a portion of the secured information is encrypted prior to storing in the memory device.

4. The system of claim 3, wherein when the one or more user devices access the safe and the one or more data structures associated therewith, the encrypted secured information remains encrypted when presented on the interface until selected for decrypting and viewing on the interface.

5. The system of claim 1, wherein one of the plurality of user devices initiates the establishing of the safe.

6. The system of claim 5, wherein the one of the plurality of user devices initiates the defining of the one or more security rules for the safe.

7. The system of claim 1, wherein an administrator of the security management system initiates the establishing of the safe.

8. The system of claim 7, wherein the administrator initiates the defining of the one or more security rules for the safe.

9. The system of claim 1, wherein the access privilege includes at least one of read-only access and read-and-write access to at least one of the safes and the one or more data structures associated therewith.

10. The system of claim 1, wherein the operations privilege includes operations of at least one of adding, modifying, deleting, copying, and sharing between one or more of the plurality of user devices and at least one of the safes and the one or more data structures associated therewith.

11. The system of claim 1, wherein the operations privilege includes an operation of at least one of executing an application, accessing a document, and following a link to access an account presented on the interface and providing a portion of the secured information to execute the application, to access the document, and to access the account.

12. The system of claim 11, further including verifying the one or more of the user devices performing the operation is compatible with the at least one of application to be executed, document to be accessed, and account to be accessed prior to initiating performance of the operation.

13. A method for collaborative management of secured information, the method comprising:
storing a plurality of data structures in a memory device, each of the data structures including secured information;
establishing at least one safe associated with one or more of the data structures;
defining one or more security rules for the safe, each of the security rules governing for one or more of a plurality of user devices at least one of:
an access privilege for granting or for denying access to at least one of the safe and the one or more data structures associated therewith by the one or more user devices via an interface; and
an operations privilege for enabling or for disabling performance of operations upon at least one of the safe and the one or more data structures associated therewith initiated by the one or more user devices from the interface; and
controlling, by application of the security rules, at least one of access to and operations performed upon the at least one safe and the one or more data structures associated therewith by the one or more user devices.

14. The method of claim 13, wherein the secured information includes at least one of login credentials, cryptographic keys, documents, and data strings.

15. The method of claim 13, further including encrypting at least a portion of the secured information prior to storing in the memory device.

16. The method of claim 15, wherein when the one or more user devices access the safe and the one or more data structures associated therewith, the encrypted secured information remains encrypted when presented on the interface until selected for decrypting and viewing on the interface.

17. The method of claim 13, wherein one of the plurality of user devices initiates establishing the safe.

18. The method of claim 17, wherein the one of the plurality of user devices initiates defining the one or more security rules for the safe.

19. The method of claim 13, wherein an administrator initiates establishing the safe.

20. The method of claim 19, wherein the administrator initiates defining the one or more security rules for the safe.

21. The method of claim 13, wherein the access privilege includes at least one of read-only access and read-and-write access to at least one of the safes and the one or more data structures associated therewith.

22. The method of claim 13, wherein the operations privilege includes operations of at least one of adding, modifying, deleting, copying, and sharing between one or more of the plurality of user devices at least one of the safe and the one or more data structures associated therewith.

23. The method of claim 13, wherein the operations privilege includes an operation of at least one of executing an application, accessing a document, and following a link to access an account presented on the interface and providing a portion of the secured information configured as credentials to execute the application, to access the document, and to access the account.

24. The method of claim 23, further including:
verifying the one or more user devices performing the operation is compatible with the at least one of application to be executed, document to be accessed, and account to be accessed prior to initiating performance of the operation.
